(19) United States
(12) Patent Application Publication
(10) Pub. No.: US 2026/0349515 A1
(43) Pub. Date: Nov. 5, 2026

(54) TACTILE PRESENTATION DEVICE

(71) Applicant: SONY GROUP CORPORATION, TOKYO (JP)

(72) Inventors: HIROSHI SUZUKI, TOKYO (JP); YUSUKE NAKAGAWA, TOKYO (JP)

(21) Appl. No.: 19/486,972

(22) PCT Filed: Apr. 19, 2024
(86) PCT No.: PCT/JP2024/015559

§ 371 Date: Nov. 24, 2025

(30) Foreign Application Priority Data
Jun. 13, 2023 (JP) 2023-096912

(51) Int. Cl. G06F 3/01; G06F 3/0346; G06F 3/0354

(52) U.S. Cl. CPC G06F 3/016; G06F 3/0346; G06F 3/03545

(57) ABSTRACT

A tactile sensation by a shear force is presented to a user by a linear motion by a TSA. A tactile presentation device including at least one or more motors; a first rotating body that rotates by a driving force of the motor, and a second rotating body that rotates according to rotation of the first rotating body; and a wire group attached to the first rotating body and the second rotating body, in which the wire group includes: a first section in which a degree of twist changes by the driving force of the motor; and a second section connected to the first section via a separator, the second section in which the degree of twist does not change by the driving force of the motor, and in the second section of the wire group, an effector including a protrusion protruding outward from the tactile presentation device and movable in a linear direction by the driving force of the motor is provided.

### TECHNICAL FIELD

The present disclosure relates to a tactile presentation device.

### BACKGROUND ART

Recently, a rotation-linear motion transmission mechanism using a twisted string has been developed. For example, Patent Document 1 discloses a twisted string-type actuator capable of controlling driving of a driving target (for example, rotation of a finger joint of a robot hand and the like) by adjusting a degree of twist of two sets of twisted strings.

### CITATION LIST

### Patent Document

Patent Document 1: Japanese Patent Application Laid-Open No. 2008-79371

### SUMMARY OF THE INVENTION

### Problems to be Solved by the Invention

Such twisted string-type actuator is called as a twisted string actuator (TSA), is small and lightweight, and can obtain a high reduction ratio. An application technology utilizing a characteristic of a linear motion of such TSA is expected.

Therefore, the present disclosure proposes a novel and improved tactile presentation device capable of presenting a tactile sensation by a shear force to a user by a linear motion by a TSA.

### Solutions to Problems

According to a certain aspect of the present disclosure, provided is a tactile presentation device including at least one or more motors, a first rotating body that rotates by a driving force of the motor, and a second rotating body that rotates according to rotation of the first rotating body, and a wire group attached to the first rotating body and the second rotating body, in which the wire group includes a first section in which a degree of twist changes by the driving force of the motor, and a second section connected to the first section via a separator, the second section in which the degree of twist does not change by the driving force of the motor, and in the second section of the wire group, an effector including a protrusion protruding outward from the tactile presentation device and movable in a linear direction by the driving force of the motor is provided.

### BRIEF DESCRIPTION OF DRAWINGS

FIG. 1 is an explanatory diagram for explaining an outline of a tactile presentation device 1 according to the present disclosure.

FIG. 2 is an explanatory diagram for explaining an inner configuration example of the tactile presentation device 1 according to the present disclosure.

FIG. 3A is an explanatory diagram for explaining a mechanism in which an effector 100 moves in a linear direction by a TSA according to the present disclosure.

FIG. 3B is an explanatory diagram for explaining the mechanism in which the effector 100 moves in the linear direction by the TSA according to the present disclosure.

FIG. 4 is a schematic diagram illustrating an A-A cross section of the tactile presentation device 1 illustrated in FIG. 1.

### MODE FOR CARRYING OUT THE INVENTION

Hereinafter, a preferred embodiment of the present disclosure will be described in detail with reference to the accompanying drawings. Note that, in the present specification and drawings, components having substantially the same functional configuration are denoted by the same reference sign, and redundant description is omitted.

Note that, the description will be given in the following order.
1. Outline of Tactile Presentation Device
2. Functional Configuration Example
3. Modification
4. Supplementary Notes

### 1. Outline of Tactile Presentation Device

In a tactile presentation technology, it has been clarified that it is possible to present a pseudo weight feeling and the like to a user by skin shear stimulation. For example, by applying shear stimulation to the skin of the user's finger, it is possible to present a weight feeling and the like to the user's fingertip. In this manner, in order to present the weight feeling and the like to the user, it is necessary to exert a sufficient linear motion torque that deforms the user's skin in a shear direction.

However, in general, in order to exert the sufficient linear motion torque that deforms the user's skin in the shear direction, a volume and a weight of a device equipped with the tactile presentation technology might be increased. According to a tactile presentation device according to a certain comparative example, there is a technology of generating skin shear stimulation by a system of winding a belt. In such system of winding a belt, a high linear motion torque can be exerted with a small size, but there might be a restriction regarding a shape of a device adopting this system. For example, it might be difficult to apply a tactile presentation technology by a system of winding a belt to a handheld device such as a pen or a mouse.

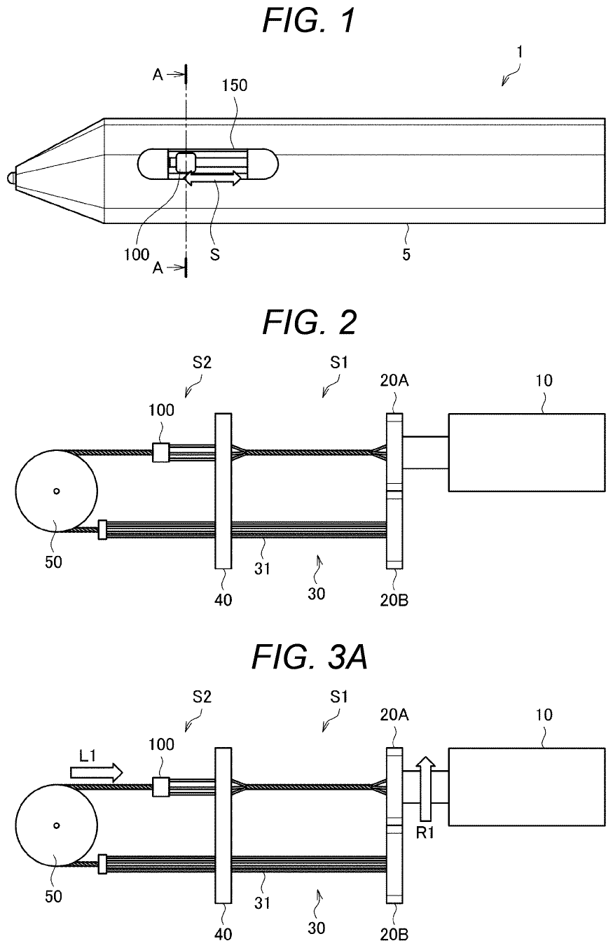

A technical idea according to one embodiment of the present disclosure has been conceived focusing on the above-described points, and provides a tactile presentation technology with a small and simple configuration. First, an outline of a tactile presentation device 1 according to the present disclosure will be described with reference to FIG. 1.

FIG. 1 is an explanatory diagram for explaining the outline of the tactile presentation device 1 according to the present disclosure. The tactile presentation device 1 according to the present disclosure is a pen-type device that presents a tactile sensation to a user by a TSA. Note that, although a specific example will be described later, the tactile presentation device 1 according to the present disclosure is not limited to the pen-type device.

The tactile presentation device 1 includes, for example, a housing 5. A groove 150 is formed on the housing 5. A protrusion 101 (FIG. 4) of an effector 100 protrudes from a hole of the groove 150. Structures of the effector 100 and the groove 150 will be described later in detail.

First, the user grips the tactile presentation device 1 and brings the finger (for example, index finger) of the user into contact with a surface of the protrusion 101 (FIG. 4) of the effector 100 illustrated in FIG. 1. Then, the tactile presentation device 1 according to the present disclosure presents a tactile sensation to the user by applying a shear force to the user's finger that comes into contact with the surface of the protrusion 101 (FIG. 4) of the effector 100.

More specifically, the tactile presentation device 1 includes a TSA as a mechanism that moves the effector 100 illustrated in FIG. 1 in a linear direction S (also referred to as a shear direction). Then, by movement of the effector 100 in the linear direction S, it is possible to present the tactile sensation by the shear force to the user's finger.

The tactile presentation device 1 can be used as, for example, an operation device that cooperates with a virtual reality (VR) device and the like. In this case, the user can perform various operations in a VR space by gripping the tactile presentation device 1.

Furthermore, the tactile presentation device 1 may be equipped with various sensors such as an infrared light-emitting diode (LED) or an inertial measurement unit (IMU) for position detection. As a result, a position of the tactile presentation device 1 can be detected by a stereo camera or a computer, and the tactile presentation device 1 can be used as an input device in a three-dimensional space such as the VR space.

For example, on the VR space, coordinates of a virtual pointer indicating the position of the tactile presentation device 1 on the VR space can be defined using sensor values obtained by various sensors included in the tactile presentation device 1 described above (for example, sensor values obtained by the infrared LED, IMU or the like). Then, the tactile presentation device 1 may perform tactile presentation to the user when the virtual pointer touches a virtual object defined in the VR space.

More specifically, when the virtual pointer touches the virtual object defined in the VR space, the tactile presentation device 1 controls the movement of the effector 100 in the linear direction S, so that it is possible to present a pseudo weight feeling by the shear force to the user who grips the tactile presentation device 1. In this manner, the tactile presentation device 1 can provide VR interaction by presenting the tactile sensation to the user.

Furthermore, the tactile presentation device 1 may control such that a position of the effector 100 reciprocates at a constant cycle. As a result, the tactile presentation device 1 can present the tactile sensation by oscillation (for example, oscillation by a low frequency) to the user who grips the tactile presentation device 1.

Furthermore, the tactile presentation device 1 may be equipped with two or more infrared LEDs. For example, the tactile presentation device 1 may be equipped with the infrared LED on each of a distal end side and a terminal end side, and may detect rotation of the tactile presentation device 1 from relative coordinates of the two infrared LEDs. The rotation of the tactile presentation device 1 detected in this manner may be used as information of the virtual pointer in the VR space.

Furthermore, the tactile presentation device 1 may detect a rotation speed of a motor used for driving the TSA by a sensor such as a rotary encoder. Moreover, the tactile presentation device 1 may use the rotation speed of the motor detected by the sensor such as the encoder for controlling the shear force to be presented to the user.

Furthermore, the tactile presentation device 1 may control the shear force to be presented to the user by using the position of the effector 100 detected by a distance sensor and the like.

According to the control as described above, the tactile presentation device 1 can provide, for example, a feeling of holding the virtual object in the VR space, a feeling of releasing the virtual object, a feeling of colliding with the virtual object or the like to the user as various tactile sensations.

Note that, although the TSA is focused as a rotation-linear motion transmission mechanism capable of obtaining a high reduction ratio with a simple and lightweight configuration, this can generate only a traction force in principle, so that this can exert only a linear motion torque in one direction. Assuming that the tactile sensation is presented to the user, it is desirable that the linear motion torque toward both of one side and the other side (hereinafter, expressed as both directions in some cases) in the linear direction S can be exerted.

In this manner, in a case where it is desired to exert the linear motion torque in both the directions, a case where a system using a plurality of TSAs including a plurality of wire groups and a plurality of motors that drives the plurality of wire groups or a system using a restoring force of a spring is adopted can be assumed.

However, in a case where the system using the plurality of TSAs is adopted, there is a possibility that a structure becomes complicated, and it might be disadvantageous in terms of a degree of freedom of a shape, a volume, or a weight. Furthermore, in a case where the system using a restoring force of a spring is adopted, the spring and the TSA are pushed and pulled, which might be disadvantageous in terms of efficiency.

Therefore, the tactile presentation device 1 according to the present disclosure has one of characteristics that the effector 100 can be driven in both the directions in the linear direction S by one set of TSAs. Hereinafter, a mechanism of moving the effector 100 in both the directions in the linear direction S by the TSA included in the tactile presentation device 1 according to the present disclosure will be described in detail with reference to FIG. 2.

### 2. Functional Configuration Example

FIG. 2 is an explanatory diagram for explaining an inner configuration example of the tactile presentation device 1 according to the present disclosure. As illustrated in FIG. 2, the tactile presentation device 1 according to the present disclosure includes, as the TSA, a motor 10, a gear 20, a wire group 30, a separator 40, and a pulley 50.

### (Motor 10)

The motor 10 according to the present disclosure rotates the gear 20 to be described later by a driving force of the motor 10. For example, the motor 10 rotates a drive shaft of the motor 10 by the driving force of the motor 10. Then, the motor 10 rotates a main gear 20A connected to the drive shaft of the motor 10 in the same direction as a rotation direction of the drive shaft of the motor 10.

### (Gear 20)

The gear 20 according to the present disclosure is an example of a rotating body that rotates by the driving force of the motor 10. As illustrated in FIG. 2, the tactile presentation device 1 according to the present disclosure may include the main gear 20A and a sub gear 20B. Here, the main gear 20A is an example of a first rotating body, and the sub gear 20B is an example of a second rotating body.

Furthermore, the main gear 20A may be directly connected to the drive shaft of the motor 10, and the main gear 20A and the sub gear 20B may mesh with each other as illustrated in FIG. 2. Then, the main gear 20A rotates in the same direction as the rotation direction of the drive shaft of the motor 10 by the driving force of the motor 10. Moreover, the sub gear 20B interlocks with the rotation of the main gear 20A, and rotates in a direction opposite to the rotation direction of the main gear 20A (that is, the rotation direction of the drive shaft of the motor 10).

### (Wire Group 30)

The wire group 30 according to the present disclosure includes a plurality of wires 31 for TSA. As illustrated in FIG. 2, the wire group 30 is attached to the main gear 20A and the sub gear 20B.

The wire group 30 includes a first section S1 in which a degree of twist changes by the driving force of the motor 10. Furthermore, the wire group 30 includes a second section S2 connected to the first section S1 via the separator 40, in which the degree of twist is not changed by the driving force of the motor 10.

In other words, the first section S1 and the second section S2 are separated with the separator 40 as a boundary. More specifically, a section from the gear 20 (main gear 20A and sub gear 20B) to the separator 40 is the first section S1, and the other section is the second section S2.

Furthermore, an initial state of the wire group 30 in the first section S1 is a twisted state in one of the main gear 20A side and the sub gear 20B side, and a non-twisted state in the other of the main gear 20A side and the sub gear 20B side. In FIG. 2, as the initial state of the wire group 30 in the first section S1, a state in which the wire group 30 on the main gear 20A side is twisted and the wire group 30 on the sub gear 20B side is not twisted is exemplified.

Note that, the initial state of the wire group 30 in the first section S1 is not limited to the example illustrated in FIG. 2. The initial state of the wire group 30 in the first section S1 may be a state in which the wire group 30 on the main gear 20A side is not twisted and the wire group 30 on the sub gear 20B side is twisted.

Furthermore, the initial state of the wire group 30 in the first section S1 may be a state in which both the wire groups 30 on the main gear 20A side and the sub gear 20B side are twisted as long as the degree of twist of the wire group 30 is different.

Furthermore, the tactile presentation device 1 includes the effector 100 movable in the linear direction by the driving force of the motor 10 in the second section S2 of the wire group 30. Furthermore, the effector 100 includes the protrusion 101 (FIG. 4) protruding outward from the tactile presentation device 1 (more specifically, the housing 5).

Furthermore, the wire group 30 in the second section S2 is folded back by the pulley 50. In this manner, the tactile presentation device 1 includes the pulley 50, so that the tactile presentation by one set of motor 10 and wire group 30 is implemented.

Note that, in the present specification, an example will be mainly described in which the wire group 30 includes six wires 31, but the number of wires 31 included in the wire group 30 according to the present disclosure is not limited to such an example. For example, the wire group 30 may include two to five wires 31, or may include seven or more wires 31.

Furthermore, although the example illustrated in FIG. 2 is an example in which the effector 100 is provided in the second section S2 on the main gear 20A side, the effector 100 may be provided in the second section S2 on the sub gear 20B side, or may be provided on both the main gear 20A side and the sub gear 20B side.

Furthermore, the main gear 20A is not necessarily directly connected to the drive shaft of the motor 10. In other words, the main gear 20A may be indirectly connected to the drive shaft of the motor 10. In this case, a component (for example, a gear) for transmitting the driving force of the motor 10 may be connected to each of the drive shaft of the motor 10 and the main gear 20A.

The inner configuration example of the tactile presentation device 1 according to the present disclosure has been described above. According to such configuration of the tactile presentation device 1, in the tactile presentation device 1, by rotating the drive shaft of the motor 10 by the driving force of the motor 10, a twisting motion and a releasing motion of the wire group 30 connected to each of the main gear 20A and the sub gear 20B are interlocked, so that the effector 100 can be moved in the linear direction.

Furthermore, the tactile presentation device 1 can move the effector 100 in both the directions in the linear direction by changing the rotation direction of the drive shaft of the motor 10. In this manner, when the effector 100 is moved in the linear direction by the driving force of the motor 10 illustrated in FIG. 2, the tactile sensation can be presented to the user by the protrusion 101 (FIG. 4) of the effector 100.

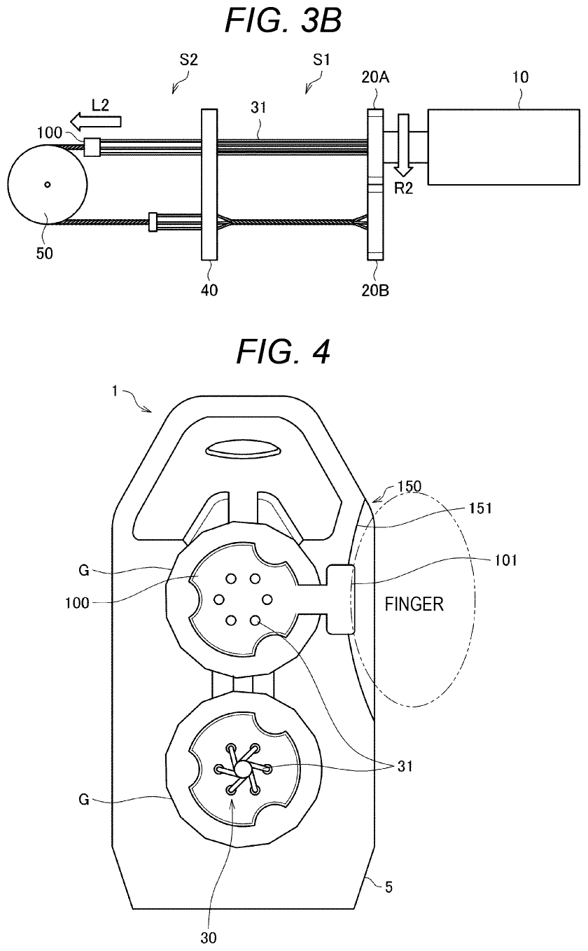

FIGS. 3A and 3B are explanatory diagrams for explaining a mechanism in which the effector 100 moves in the linear direction by the TSA according to the present disclosure. For example, in a case where the drive shaft of the motor 10 rotates in a first rotation direction R1 as illustrated in FIG. 3A, the main gear 20A also rotates in the first rotation direction R1, and the sub gear 20B rotates in a direction opposite to the first rotation direction R1 (that is, a second rotation direction R2 illustrated in FIG. 3B).

Here, as illustrated in FIG. 3A, when the drive shaft of the motor 10 rotates in the first rotation direction R1, the degree of twist of the wire group 30 in the first section S1 increases in the section from the main gear 20A to the separator 40, and decreases in the section from the sub gear 20B to the separator 40. In other words, the fact that the degree of twist of the wire group 30 decreases means that the degree of twist of the wire group 30 approaches a release side.

In this manner, when the degree of twist increases in the section from the main gear 20A to the separator 40 and the degree of twist decreases in the section from the sub gear 20B to the separator 40, as illustrated in FIG. 3A, the effector 100 moves to a front side L1 (right side in FIG. 3A) in the linear direction.

In contrast, as illustrated in FIG. 3B, when the drive shaft of the motor 10 rotates in the second rotation direction R2 opposite to the first rotation direction illustrated in FIG. 3A, the degree of twist of the wire group 30 in the first section S1 decreases in the section from the main gear 20A to the separator 40, and increases in the section from the sub gear 20B to the separator 40.

In this manner, when the degree of twist decreases in the section from the main gear 20A to the separator 40 and the degree of twist increases in the section from the sub gear 20B to the separator 40, as illustrated in FIG. 3B, the effector 100 moves to a back side L2 (left side in FIG. 3B) in the linear direction.

When the effector 100 moves toward the front side L1 or the back side L2 in the linear direction, the shear force on the front side L1 or the back side L2 is applied to the user's finger in contact with the protrusion 101 (FIG. 4) of the effector 100, and the tactile sensation can be presented to the user.

Note that, the mechanism by which the effector 100 moves in the linear direction by the TSA according to the present disclosure is not limited to the above-described example. For example, the initial state of the wire group 30 in the first section S1 may be appropriately changed in design.

More specifically, it is possible to be designed such that, when the drive shaft of the motor 10 rotates in the first rotation direction R1, the degree of twist of the wire group 30 in the first section S1 decreases in the section from the main gear 20A to the separator 40, and increases in the section from the sub gear 20B to the separator 40.

In this case, when the drive shaft of the motor 10 rotates in the second rotation direction R2, the degree of twist of the wire group 30 in the first section S1 increases in the section from the main gear 20A to the separator 40, and decreases in the section from the sub gear 20B to the separator 40.

Furthermore, another gear for transmitting the rotation of the main gear 20A to the sub gear 20B may be provided between the main gear 20A and the sub gear 20B. For example, in a case where one gear is connected between the main gear 20A and the sub gear 20B, when the drive shaft of the motor 10 rotates in the first rotation direction R1, the main gear 20A and the sub gear 20B rotate in the first rotation direction. Therefore, a winding direction of the wire can be changed in design in such a manner that, in a case where the drive shaft of the motor 10 rotates in the first rotation direction R1, the degree of twist of the wire group 30 in the first section S1 increases in the section from the main gear 20A to the separator 40, and decreases in the section from the sub gear 20B to the separator 40.

FIG. 4 is a schematic diagram illustrating an A-A cross section of the tactile presentation device 1 illustrated in FIG. 1. Since the tactile presentation device 1 according to the present disclosure presents the tactile sensation to the user by applying the shear force to the user's skin, a structure in which the user's finger comes into contact with both the effector 100 that is movable and the housing 5 that does not move is desirable.

Therefore, as illustrated in FIG. 4, the tactile presentation device 1 according to the present disclosure is desirably designed in such a manner that the protrusion 101 of the effector 100 protrudes to a certain extent (for example, about several millimeters) from the hole of the groove 150 of the housing 5.

Furthermore, assuming a state in which the user's finger is in contact with only the surface of the protrusion 101 of the effector 100, in a case where the effector 100 moves, the user's finger in contact with the effector 100 also moves similarly, so that no shear force is presented to the user. Therefore, it is desirable that an inclined portion 151 as illustrated in FIG. 4 is formed on the surface of the groove 150 of the housing 5 so that the user's finger easily comes into contact with the housing 5.

According to the structure of the tactile presentation device 1 as described above, the user's finger can be brought into contact with both the surface of the protrusion 101 of the effector 100 and the inclined portion 151 of the housing 5. As a result, the tactile presentation device 1 can more effectively present the shear force to the user's finger by moving the effector 100.

Furthermore, the surface of the protrusion 101 of the effector 100 may be formed using a material (for example, silicon, rubber and the like) having a frictional coefficient of a predetermined value or larger. As a result, the shear force can be more easily transmitted to the user. Furthermore, irregularities may be formed on the surface of the protrusion 101 of the effector 100. As surface roughness of the surface of the protrusion 101 of the effector 100 increases in this manner, the frictional force applied to the user's finger increases, and the shear force can be more easily transmitted to the user.

Furthermore, when the user's finger comes into contact with the surface of the protrusion 101 of the effector 100, a force is applied to the effector 100 in a depression direction (that is, a left direction in FIG. 4) by the finger. Therefore, a guide member G that restricts the movement of the effector 100 in a direction other than the front side L1 and the back side L2 in the linear direction may be provided so that the effector 100 is not moved in the depression direction by the force in the depression direction generated by the contact of the finger.

The functional configuration example of the tactile presentation device 1 according to the present disclosure has been described above. Subsequently, a modification of the tactile presentation device 1 according to the present disclosure will be described. Any one of first to third modifications described below may be adopted, or a plurality of them may be adopted in combination.

### 3. Modifications

### (First Modification)

The tactile presentation device 1 according to the first modification may be equipped with an oscillation actuator such as an LRA or a VCM. As a result, the tactile presentation device 1 can present a wider variety of tactile sensations to the user by using the oscillation actuator and the above-described TSA in combination.

For example, the tactile presentation device 1 can enhance an effect of oscillation by simultaneously driving the oscillation actuator and the TSA at the time of contact with the virtual object in the VR space.

Furthermore, for example, the tactile presentation device 1 may present a state change by presenting oscillation by the oscillation actuator when coming into contact with the virtual object in the VR space, and giving a shear stimulation by the TSA when lifting the virtual object. In this manner, by combining the oscillation actuator and the TSA, it is possible to switch a tactile presentation method to the user.

### (Second Modification)

In FIGS. 2 and 3, the mechanism of the TSA that moves the effector 100 in the linear direction by one motor 10 and one set of wire group 30 has been described, but the TSA of the tactile presentation device 1 according to the present disclosure is not limited to such an example.

For example, the tactile presentation device 1 according to the second modification may be equipped with the motor 10 that drives the main gear 20A and the motor 10 that drives the sub gear 20B. In this case, since the rotation of the main gear 20A is not interlocked with the sub gear 20B, the tactile presentation device 1 may include another rotating body instead of the gear 20 (main gear 20A and sub gear 20B).

### (Third Modification)

Furthermore, although the example in which the wire group 30 illustrated in FIGS. 2 and 3 is folded back by the pulley 50 to be disposed in a U shape in the tactile presentation device 1 has been described, the tactile presentation device 1 according to the third modification does not necessarily include the pulley 50.

For example, in the tactile presentation device 1 according to the third modification, the wire group 30 may be arranged in an I shape. In this case, the main gear 20A and the sub gear 20B may be arranged on one end side and the other end side of a straight line, respectively.

Furthermore, in a case where the drive shaft of the motor 10 and the main gear 20A are connected, the tactile presentation device 1 according to the third modification may further include a gear that interlocks the rotation of the main gear 20A with the sub gear 20B.

Furthermore, the tactile presentation device 1 according to the third modification may be equipped with the motor 10 connected to the main gear 20A and the motor 10 connected to the sub gear 20B. In this case, since the rotation of the main gear 20A is not interlocked with the sub gear 20B, the tactile presentation device 1 may include another rotating body instead of the gear 20 (main gear 20A and sub gear 20B).

### 4. Additional Notes

While the preferred embodiment of the present disclosure has been described in detail with reference to the accompanying drawings, the technical scope of the present disclosure is not limited to such examples. It is obvious that those with ordinary skill in the technical field of the present disclosure can conceive of various alterations or corrections within the scope of the technical idea recited in claims, and it is naturally understood that those alterations or corrections also fall within the technical scope of the present disclosure.

For example, in the present specification, the example in which the tactile presentation device 1 is the pen-type device has been mainly described, but the tactile presentation device 1 according to the present disclosure is not limited to such example. For example, the tactile presentation device 1 according to the present disclosure may be a wristband-type device in which the effector 100 is in contact with the wrist surface, or may be used as an alternative means for direction presentation or presentation to the fingertip.

Furthermore, the tactile presentation device 1 may be a head mounted display (HMD). In this case, the tactile presentation device 1 in which at least one or more TSAs can be arranged such that the effector 100 is in contact with the forehead skin can be used to present the user with an acceleration feeling or wind.

Furthermore, the tactile presentation device 1 may be a bracelet-type device or a ring-type device. In this manner, the shape or application destination of the tactile presentation device 1 is not particularly limited.

Furthermore, the effects described in the present specification are merely exemplary or illustrative, and are not restrictive. That is, the technology according to the present disclosure can produce other effects that are apparent to those skilled in the art from the description of the present specification, in combination with or instead of the effects described above.

Note that, the following configurations also fall within the technical scope of the present disclosure.

(1)

A tactile presentation device
including:
at least one or more motors;
a first rotating body that rotates by a driving force of the motor, and a second rotating body that rotates according to rotation of the first rotating body; and
a wire group attached to the first rotating body and the second rotating body, in which
the wire group
includes:
a first section in which a degree of twist changes by the driving force of the motor; and
a second section connected to the first section via a separator, the second section in which the degree of twist does not change by the driving force of the motor, and
in the second section of the wire group, an effector including a protrusion protruding outward from the tactile presentation device and movable in a linear direction by the driving force of the motor is provided.
   (2)

The tactile presentation device according to (1) described above,
further including:
a groove including a hole from which the protrusion of the effector protrudes.
   (3)

The tactile presentation device according to (2) described above, in which
the groove
further includes an inclined portion inclined toward the hole.
   (4)

The tactile presentation device according to any one of (1) to (3) described above, further including:
a pulley in the second section, in which
the wire group is folded back by the pulley in the second section.
   (5)

The tactile presentation device according to (4) described above, in which
the at least one or more motors are one motor, and
the first rotating body and the second rotating body are gears that mesh with each other.
   (6)

The tactile presentation device according to (5) described above, in which
a drive shaft of the motor is connected to any one of the first rotating body or the second rotating body.
   (7)

The tactile presentation device according to any one of (1) to (6) described above, further including:
an oscillation actuator capable of presenting oscillation.
   (8)

The tactile presentation device according to (7) described above,
that presents a tactile sensation by combining a shear force by the effector and the oscillation by the oscillation actuator.
   (9)

The tactile presentation device according to any one of (1) to (8) described above, in which
a surface of the protrusion is formed by using a material having a frictional coefficient of a predetermined value or larger.
   (10)

The tactile presentation device according to any one of (1) to (9) described above,
further including:
a guide member that restricts movement of the effector in a direction other than the linear direction.
   (11)

The tactile presentation device according to any one of (1) to (10), further including:
a sensor that enables position detection of the tactile presentation device.
   (12)

The tactile presentation device according to (11) described above,
that performs an operation regarding tactile presentation on the basis of coordinates defined using a sensor value obtained by a sensor.
   (13)

The tactile presentation device according to any one of (1) to (12) described above,
that is a pen-type device, and
presents a tactile sensation to a user's finger by the effector.

REFERENCE SIGNS LIST

| | |
|---|---|
| 1 | Tactile presentation device |
| 5 | Housing |
| 10 | Motor |
| 20A | Main gear |
| 20B | Sub gear |
| 30 | Wire group |
| 31 | Wire |
| 40 | Separator |
| 50 | Pulley |
| 100 | Effector |
| 101 | Protrusion |
| 150 | Groove |
| 151 | Inclined portion |

1. A tactile presentation device comprising:
at least one or more motors;
a first rotating body that rotates by a driving force of the motor, and a second rotating body that rotates according to rotation of the first rotating body; and
a wire group attached to the first rotating body and the second rotating body, wherein
the wire group
includes:
a first section in which a degree of twist changes by the driving force of the motor; and
a second section connected to the first section via a separator, the second section in which the degree of twist does not change by the driving force of the motor, and
in the second section of the wire group, an effector including a protrusion protruding outward from the tactile presentation device and movable in a linear direction by the driving force of the motor is provided.

2. The tactile presentation device according to claim 1, further comprising:
a groove including a hole from which the protrusion of the effector protrudes.

3. The tactile presentation device according to claim 2, wherein
the groove
further includes an inclined portion inclined toward the hole.

4. The tactile presentation device according to claim 1, further comprising:
a pulley in the second section, wherein
the wire group is folded back by the pulley in the second section.

5. The tactile presentation device according to claim 4, wherein
the at least one or more motors are one motor, and
the first rotating body and the second rotating body are gears that mesh with each other.

6. The tactile presentation device according to claim 5, wherein
a drive shaft of the motor is connected to any one of the first rotating body or the second rotating body.

7. The tactile presentation device according to claim 1, further comprising:
an oscillation actuator capable of presenting oscillation.

8. The tactile presentation device according to claim 7,
that presents a tactile sensation by combining a shear force by the effector and the oscillation by the oscillation actuator.

9. The tactile presentation device according to claim 1, wherein
a surface of the protrusion is formed by using a material having a frictional coefficient of a predetermined value or larger.

10. The tactile presentation device according to claim 1, further comprising:
a guide member that restricts movement of the effector in a direction other than the linear direction.

11. The tactile presentation device according to claim 1, further comprising:
a sensor that enables position detection of the tactile presentation device.

12. The tactile presentation device according to claim 11,
that performs an operation regarding tactile presentation on a basis of coordinates defined using a sensor value obtained by a sensor.

13. The tactile presentation device according to claim 1,
that is a pen-type device, and
presents a tactile sensation to a user's finger by the effector.
